(19) United States
(12) Patent Application Publication
(10) Pub. No.: US 2026/0030477 A1
(43) Pub. Date: Jan. 29, 2026

(54) UPDATING NEURAL NETWORK PARAMETERS VIA ENCODED MESSAGES

(71) Applicant: Synaptics Incorporated, San Jose, CA (US)

(72) Inventor: Piotr Krzyzaniak, Rybnik (PL)

(73) Assignee: Synaptics Incorporated, San Jose, CA (US)

(21) Appl. No.: 18/781,797

(22) Filed: Jul. 23, 2024

(51) Int. Cl. G06N 3/04

(52) U.S. Cl. CPC G06N 3/04

(57) ABSTRACT

This disclosure provides methods, devices, and systems for machine learning. The present implementations more specifically relate to systems and techniques for updating neural network (NN) parameters via encoded messages. An input device may implement a NN model trained to perform inferencing on input tokens received via one or more sensors of the input device. In some aspects, the input device receives a first input token via the one or more sensors, determines that the first input token includes an encoded message, extracts NN information from the encoded message, and updates one or more parameters of the NN model based on the extracted NN information. In some other aspects, the input device receives a second input token via the one or more sensors, determines that the second input token does not include an encoded message, and performs an inferencing operation on the second input token based on the updated NN model.

### TECHNICAL FIELD

The present implementations relate generally to machine learning, and specifically to updating neural network parameters via encoded messages.

### BACKGROUND OF RELATED ART

Artificial intelligence (AI) is increasingly integrated into various devices and systems, such as AI-based consumer electronics, security systems that use AI-based audio analysis to identify suspicious sounds, virtual assistants that use neural networks to understand users' spoken commands, and traffic control systems that use AI-based computer vision to detect vehicles, among other examples. A core component of many AI systems is a neural network (NN), which operates using a set of parameters (e.g., weights and biases) to generate decisions, inferences, and/or predictions. Devices that implement AI technologies are generally referred to as “AI devices.” The accuracy and performance of an AI device is highly dependent on the quality and training of its NN model.

The parameters of a NN model can be updated (e.g., using backpropagation techniques) to maintain and improve the performance of the AI device. Some updates can be delivered over the Internet via a wired or wireless network (such as a local area network (LAN) or a wireless LAN (WLAN)). However, many AI devices lack network connectivity or sufficient bandwidth to receive NN updates. Furthermore, some AI devices have NNs that are hardcoded onto silicon chips with fixed parameters that are set during manufacturing, such that updating the parameters may be difficult or impossible without physically replacing the physical hardware.

Thus, after a NN model is deployed on an AI device, the AI device often cannot benefit from improvements to the NN model (which could otherwise improve the adaptability and long-term performance of the device). Thus, there is a need to enable more efficient and flexible updates to NN models that are already deployed in AI devices.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of updating one or more parameters of a neural network (NN) model. The method may be performed by an input device implementing the NN model, and the NN model may be trained to perform inferencing on input tokens received via one or more sensors of the input device. The method includes steps of receiving a first input token via the one or more sensors, determining that the first input token includes an encoded message, extracting NN information from the encoded message, and updating one or more parameters of the NN model based on the extracted NN information.

Another innovative aspect of the subject matter of this disclosure can be implemented in an input device that includes one or more sensors, a neural network (NN) model trained to perform inferencing on input tokens received via the one or more sensors, a processing system, and a memory. The memory stores instructions that, when executed by the processing system, cause the input device to perform operations including receiving a first input token via the one or more sensors, determining that the first input token includes an encoded message, extracting NN information from the encoded message, and updating one or more parameters of the NN model based on the extracted NN information.

### BRIEF DESCRIPTION OF THE DRAWINGS

The present implementations are illustrated by way of example and are not intended to be limited by the figures of the accompanying drawings.

FIG. 1 shows a block diagram of an example input device, according to some implementations.

FIG. 2 shows a block diagram of an example data analysis system, according to some implementations.

FIG. 3 shows a block diagram of an example machine learning system, according to some implementations.

FIG. 4A shows an example input token that can be captured by a computer vision system, according to some implementations.

FIG. 4B shows another example input token that can be captured by a computer vision system, according to some implementations.

FIG. 5 shows a block diagram of an example input device, according to some implementations.

FIG. 6 shows an illustrative flowchart depicting an example operation for updating neural network parameters, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, many existing artificial intelligence (AI) devices are unable to receive updates to their neural network (NN) models once the models are deployed. Accordingly, such AI devices are unable to benefit from improvements to the NN models that could otherwise improve the adaptability and long-term performance of such devices. Aspects of the present disclosure provide systems and methods for efficiently and flexibly updating NN models that are already deployed in AI devices.

Machine learning (ML) is a technique for improving the ability of a computer system or application to perform a specific task. During a training phase, a machine learning system is provided with multiple “answers” and a large volume of raw input data. The machine learning system analyzes the input data to learn a set of rules (also referred to as the “machine learning model” or “NN model”) that can be used to map the input data to the answers. During an inferencing phase, the machine learning system uses the trained machine learning model to infer answers from new input data.

Deep learning is a particular form of ML in which the inferencing and training phases are performed over multiple layers. Deep learning architectures are often referred to as “artificial neural networks” (ANN) due to the manner in which information is processed (similar to a biological nervous system). For example, each layer of an ANN may be composed of one or more “neurons.” Each layer of neurons may perform a different transformation on the output data from a preceding layer so that the final output of the NN results in the desired inferences or classifications. The set of transformations associated with the various layers of the network is referred to as a “neural network model.” Example suitable NNs include convolutional neural networks (CNNs) and recurrent neural networks (RNN), among other examples.

Various aspects relate generally to machine learning, and more particularly, to systems and techniques for updating NN parameters via encoded messages. An input device may implement a NN model trained to perform inferencing on input tokens received via one or more sensors of the input device. An input token can be any data captured or acquired by the input device for processing via a processing pipeline that includes one or more NN models. The input device may receive an input token via the one or more sensors. In some instances, the input device may determine whether the input token includes an encoded message. If the input token includes an encoded message, the input device may extract NN information from the encoded message and update one or more parameters of the NN model based on the extracted NN information. In contrast, if the input token does not include an encoded message, the input device may perform an inferencing operation on the input token using the NN model.

By training an NN model to determine whether an input token contains an encoded message, aspects of the present disclosure can bifurcate a processing pipeline so that an input token may be passed through one of two processing paths based on whether it contains an encoded message. Accordingly, an input device implementing the NN model can process all input tokens through the same NN model that determines whether the input token should be used for inferencing (such as where the input token does not include an encoded message) or for updating the NN model's parameters (such as where the input token includes an encoded message). In this manner, the NN model can detect encoded messages using the same sensing modality that the NN model uses for inferencing.

More specifically, where the input token is classified as containing an encoded message, the token is directed to a model updating pipeline. In some implementations, the model updating pipeline may decode and extract new NN parameters from the input token and update the NN model accordingly. Conversely, where the input token is classified as not containing an encoded message, the token may be passed on to deeper layers of the NN model (also referred to as an inferencing pipeline) that generate one or more predictions or inferences based on the input token.

Particular implementations of the subject matter described in this disclosure can be implemented to realize one or more of the following potential advantages. By handling both inferencing and model updating tasks using the same input modality, aspects of the present disclosure can update existing NN models that are deployed on AI devices with limited connectivity (such as devices that lack wired or wireless connections to the Internet). This eliminates the need for separate processes or additional hardware for model updates, reduces system complexity and cost, and allows devices with limited or no Internet connectivity or devices with hardware-based NNs to update their corresponding models. Furthermore, by dynamically determining an appropriate processing path for input tokens based on the presence of encoded messages, aspects of the present disclosure enhance the adaptability and functionality of computer systems that can sense signals in the environment, such as computer vision systems and audio analysis systems.

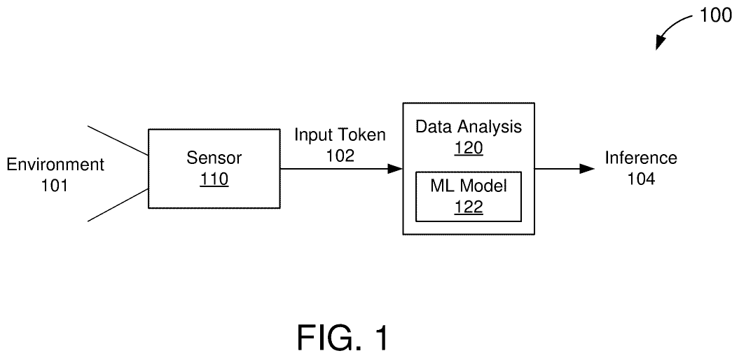

FIG. 1 shows a block diagram of an example input device 100, according to some implementations. The input device 100 includes a sensor 110 and a data analysis component 120. In some implementations, the sensor 110 and the data analysis component 120 may be provided in respective devices or systems. In some other implementations, the sensor 110 and the data analysis component 120 may be included in the same device or system (also referred to herein as an “input device”).

The sensor 110 may capture sensory data from the surrounding environment 101 and convert the sensory data into input tokens 102. Sensory data may be any information captured by the sensor 110, such as images, sound, or other measurable signals or inputs.

In some implementations, the sensor 110 may be a camera configured to capture a pattern of light from the environment 101 (also referred to as the “scene”) and convert the pattern of light to a digital image, where the digital image represents an input token 102. The digital image may include an array of pixels (or pixel values) representing the pattern of light captured from the environment 101. In some implementations, the sensor 110 may continuously (or periodically) capture a series of images representing a digital video, where the digital video represents an input token 102 or the one or more images represent input tokens 102.

As another example, the sensor 110 may be a microphone configured to capture a pattern of sound waves from the environment 101 and convert the pattern of sound waves to a digital audio signal or recording, where the digital audio signal represents an input token 102. The digital audio signal may include a sequence of sampled sound levels representing the pattern of sound waves captured in the environment 101. In some implementations, the sensor 110 may continuously (or periodically) capture a stream of audio data, where the stream of audio data represents an input token 102 or the one or more segments of audio data represent input tokens 102.

The data analysis component 120 is configured to receive the input token 102 from the sensor 110 and generate an inference 104 based on the input token 102. In some implementations, the data analysis component 120 may generate the inference 104 based on a machine learning (ML) model 122. The ML model 122 may include a set of parameters for one or more layers of a neural network (NN). In some implementations, the NN may be implemented in hardware, such as a silicon chip pre-programmed with baseline parameters during manufacturing. In some other implementations, the NN is defined in software. In some instances, one or more layers of the NN is trained to perform inferencing on the input tokens 102. For example, one or more layers of the NN may form a network of connections across multiple layers of artificial neurons that begin with an input token 102 and lead to an inference 104.

The NN architecture may include various trainable parameters, such as weights that set a strength for connections between neurons on the network of connections in the NN, bias values that influence an activation threshold of individual neurons, and/or other suitable learnable parameters specific to the NN's architecture and functions. In some implementations, the data analysis component 120 may update one or more parameters of the ML model 122 based on information encoded in the input token 102.

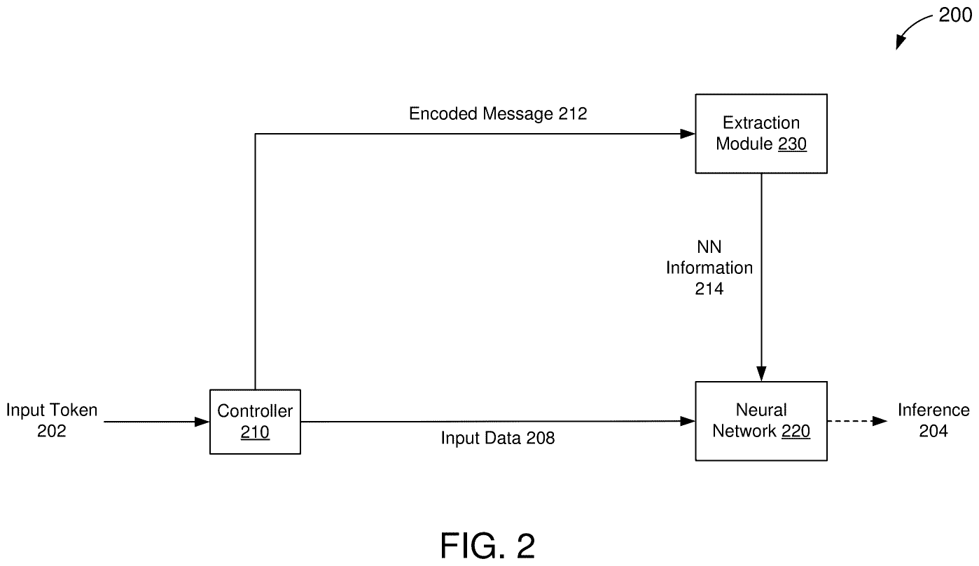

FIG. 2 shows a block diagram of an example data analysis system 200, according to some implementations. In some implementations, the data analysis system 200 may be one example of the data analysis component 120 of FIG. 1. With reference to FIG. 1, the input token 202 may be one example of the input token 102 and the inference 204 may be one example of the inference 104. The data analysis system 200 includes a controller 210, a neural network (NN) 220, and an extraction module 230. Further with reference to FIG. 1, the neural network (NN) 220 may operate based on a set of parameters associated with the ML model 122.

The controller 210 is configured to receive an input token 202 and determine whether the input token 202 includes an encoded message 212 or input data 208. In some implementations, the controller 210 may analyze the input token 202 for a known pattern (or patterns) of data indicating that the input token 202 includes an encoded message. For example, if the input token 202 is an image, the controller 210 may determine that the input token 202 includes an encoded message based on detecting a known pixel pattern in the image. As another example, if the input token 202 is an audio signal, the controller 210 may determine that the input token 202 includes an encoded message based on detecting a known audio pattern in the audio signal. In some implementations, the controller 210 may pass the input token 202 to the NN 220 or the extraction module 230 based on whether the input token 202 includes an encoded message 212 or input data 208. Specifically, if the controller 210 determines that the input token 202 includes input data 208, the controller 210 passes the input token 202, as input data 208, to the NN 220. By contrast, if the controller 210 determines that the input token 202 includes an encoded message 212, the controller 210 passes the input token 202, as the encoded message 212, to the extraction module 230. In some implementations, one or more input tokens 202 may be stored in a temporary queue or buffer (not shown for simplicity) to await processing by the controller 210.

The NN 220 is trained to perform inferencing on the input data 208. Accordingly, when the NN 220 receives input data 208 from the controller 210, the NN 220 generates an inference 204 on the input data 208 as per its default logic. In some aspects, the inference 204 may include one or more predictive or analytical outputs associated with the corresponding input data 208. For example, the NN 220 may be trained to detect vehicles that appear in images representing the input data 208, where the input token 202 is an image of the environment. However, in some other aspects, the NN 220 may be trained to perform any suitable inferencing operation.

By contrast, when an input token 202 includes an encoded message 212, the controller 210 redirects the input token 202, as the encoded message 212, to the extraction module 230. The extraction module 230 is configured to decode the encoded message 212 and extract the information encoded therein. In some implementations, the extraction module 230 may use one or more feature extraction techniques to identify or detect the encoded message 212 within the encoded message 212. For example, where the encoded message 212 is an image, example suitable feature extraction techniques may include edge detection algorithms, frequency domain analysis, and statistical analysis of various pixel values, among other examples. As another example, where the input token 202 is an audio signal, example suitable feature extraction techniques may include spectrogram analysis, analyzing Mel-Frequency Cepstral Coefficients (MFCCs), and examining zero-crossing rates, among other examples.

As described with reference to FIG. 1, the NN 220 may include various parameters that are determined through training, such as weights, bias values, and/or other suitable parameters. In some implementations, the extraction module 230 extracts NN information 214 from the encoded message 212, where the NN information 214 may include one or more updated (or “new”) parameters for the NN 220. In some aspects, the updated parameters may include one or more updated weights and/or bias values for the NN 220. Specifically, the extraction module 230 may use the NN information 214 to overwrite existing parameters of the NN 220, such as one or more existing weights and/or bias values. In some instances, the NN information 214 is extracted from more than one encoded message 212 received via more than one input token 202.

In some implementations, the NN information 214 may be analyzed to verify its accuracy before it is used to update the existing parameters of the NN 220. In some instances, the NN information 214 is temporarily stored in a buffer (not shown for simplicity) during the verification process. Example suitable techniques for verifying the accuracy of the NN information 214 include checksums, parity checks, change logs, cyclic redundancy check (CRC), hash functions, data validation rules, ML-based anomaly detection, among other examples. By verifying the accuracy of the NN information 214 before using it to update the NN 220, the data analysis system 200 maintains the integrity of the NN 220, ensures that the NN 220 is trained with reliable and accurate data, and increases the performance and trustworthiness of the NN 220. In some implementations, the controller 210 may be implemented as one or more input layers of the NN 220. In such implementations, upon receiving the input token 202, the controller 210 implemented as the one or more input layers of the NN 220 may determine whether the input token 202 includes an encoded message. Where the controller 210 implemented as the one or more input layers of the NN 220 determines that the input token 202 does not include an encoded message, the controller 210 may pass the input token 102, as input data 208, to one or more deeper layers of the NN 220. By contrast, where the controller 210 implemented as the one or more input layers of the NN 220 determines that the input token 202 includes an encoded message, the controller 210 may refrain from passing the input token 102 to deeper layers of the NN 220. Rather, the input token 202 may be passed, as the encoded message 212, to the extraction module 230. In this manner, the NN 220 is prevented from generating the inference 204 when the input token 202 includes an encoded message. Rather, when the input token 202 includes an encoded message, one or more parameters of the NN 220 may be updated based on the encoded message, such as in the manners described above with respect to the extraction module 230. In some implementations, the data analysis system 200 is restarted after the one or more NN parameters are updated. Once the NN parameters are updated, the NN 220 may perform inferences on subsequent input tokens 202 (received in the form of input data 208) using the updated parameters.

In some implementations, all of the NN model parameters may be embedded within the encoded message 212. In some other implementations, only a subset of parameters which have new or updated values may be embedded within the encoded message 212. Upon extracting the parameters (or subset of parameters) from the encoded message 212, one or more existing parameters of the NN 220 may be replaced with the updated parameters. In this manner, the NN 220 is re-tuned with one or more updated values. In some implementations, prior to encoding the new parameters within the encoded message 212, one or more data sparsity and/or data quantization techniques may be used to efficiently reduce an amount of data associated with the new parameters.

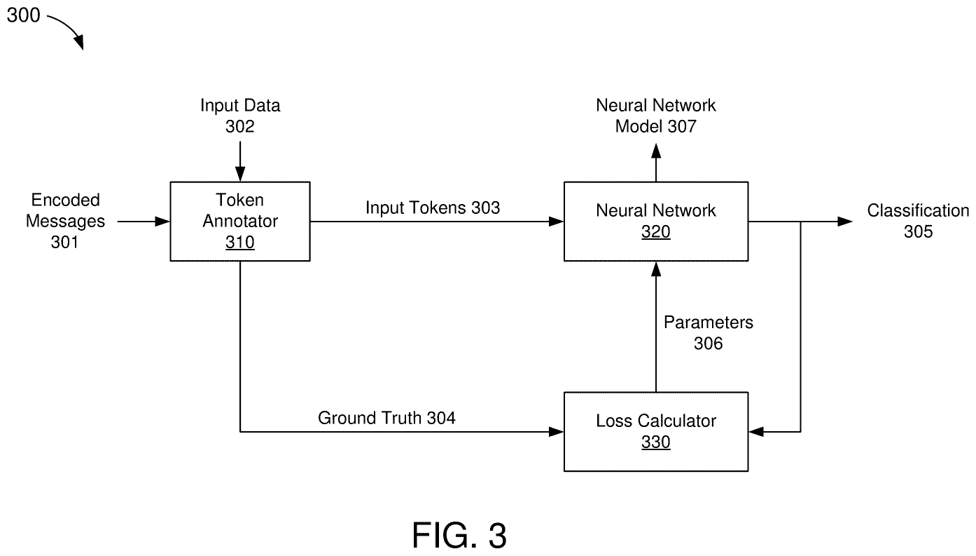

FIG. 3 shows a block diagram of an example machine learning system 300, according to some implementations. The machine learning system 300 is configured to produce a neural network (NN) model 307 based, at least in part, on a number of encoded messages 301 and input data 302. The NN model 307 may include a set of rules that can be used to classify an input token as containing an encoded message or not. In some implementations, the NN model 307 may represent one or more input layers of the ML model 122 of FIG. 1 or the NN 220 of FIG. 2.

The machine learning system 300 includes a token annotator 310, an NN 320, and a loss calculator 330. The token annotator 310 is configured to prepare input tokens 303 for analysis by the NN 320. Specifically, the token annotator 310 combines some of the input data 302 with an encoded message 301 to produce some input tokens 303 that include an encoded message 301 and some input tokens 303 that do not include an encoded message 301. In some implementations, the input data 302 and encoded messages 301 may include image or pixel data. In such implementations, the token annotator 310 may embed the encoded message 301 within the input data 302 using any known image compositing techniques, such as steganography, watermarking, or the like. In some other implementations, the input data 302 and encoded messages 301 may include audio data. In such implementations, the token annotator 310 may embed the encoded message 301 within the input data 302 using any known audio embedding techniques, such as spread spectrum embedding, phase coding, echo hiding, or the like. The token annotator 310 also produces a ground truth 304 based on the input tokens 303 generated from the input data 302 and encoded messages 301. Specifically, the ground truth 304 represents a label for each input token 303 indicating whether the input token 303 includes an encoded message or not. In some implementations, the machine learning system 300 may train the NN 320 to reproduce the ground truth 304 based on the input tokens 303. In other words, the NN 320 is trained to classify the input tokens 303 based on predicting the presence (“1”) or absence (“0”) of an encoded message in the input token 303.

The NN 320 receives the input token 303 and attempts to recreate the ground truth 304. For example, the NN 320 may form a network of connections across multiple layers of artificial neurons that begin with the input token 303 and lead to a classification 305. The connections are weighted to result in a classification 305 that closely resembles the ground truth 304. The training operation may be performed over multiple iterations. In each iteration, the NN 320 produces a classification 305 based on the weighted connections across the layers of artificial neurons, and the loss calculator 330 updates the parameters 306 associated with the connections based on an amount of loss (or error) between the classification 305 and the ground truth 304.

In some aspects, the loss calculator 330 may compare the predicted classifications output from the NN 320 with the ground truth 304, and quantify the error made by the NN 320 (as a “loss value”) using a loss function. The loss function may be a cross-entropy loss function or another loss function suitable for binary classification. The loss value represents a difference between the NN 320's predicted output and the actual target values. The loss calculator 330 uses the loss value in conjunction with an optimization algorithm (such as stochastic gradient descent) and a backpropagation process to update the parameters 306 associated with the connections within the NN 320. This process may be repeated over many iterations (“epochs”). In this manner, the loss value is minimized until certain convergence criteria are met, such as the neural network 320 being trained to make classifications 305 with an acceptable accuracy, the loss falling below a desired threshold, or after a predetermined number of training iterations. In some implementations, a performance of the NN model 307 may be evaluated on a validation dataset.

Thereafter, the NN 320 outputs the weighted connections as the NN model 307, which can be deployed in any suitable device or a component thereof. In some implementations, the NN model 307 may be deployed in an input device configured to capture input tokens and use the NN model 307 to determine whether the input tokens include encoded messages (such as the controller 210 of FIG. 2). In some implementations, the input device may include a microphone configured to capture audio-based input tokens. In some other implementations, the input device may include a camera configured to capture image-based input tokens.

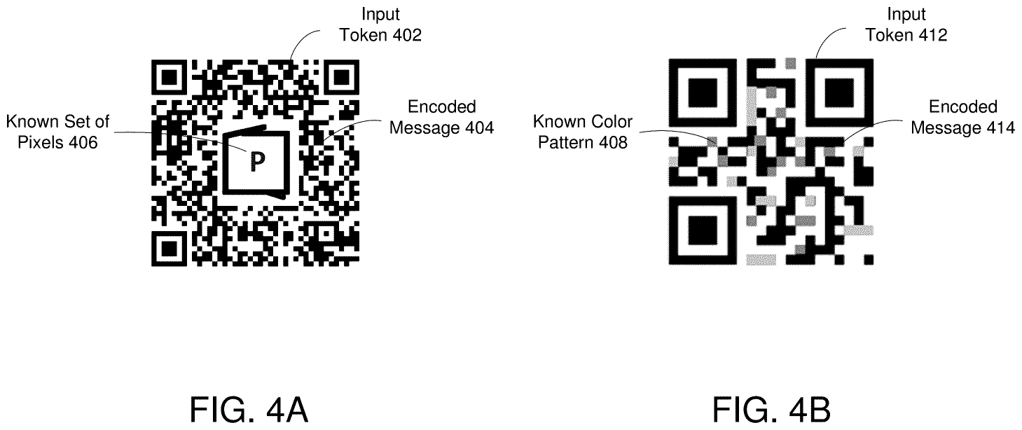

FIG. 4A shows an example input token 402 that can be captured by a computer vision system, according to some implementations. In some implementations, the computer vision system may be one example of the input device 100 of FIG. 1, where the sensor 110 of FIG. 1 is a camera that captures an image from the surrounding environment 101 (or “scene”) of FIG. 1, and the input token 102 of FIG. 1 is an example representation of the captured image. Once captured, the input token 402 may be analyzed by a data analysis component, such as the data analysis component 120 described in connection with FIG. 1 or the controller 210 described in connection with FIG. 2, to determine whether the input token 102 includes an encoded message. The input token 402 includes an encoded message 404, as further described below. It is to be understood that the example input token 402 may represent a portion of the captured image, where the full captured image is not shown for simplicity.

As described with reference to FIG. 2, updated parameters for a neural network (NN) may be embedded within the encoded message 404. For the example input token 402, the updated parameters are encoded within a quick-response (QR) code. In some aspects, encoding the updated parameters in the QR code may include, for example, converting the updated parameters into a suitable format (such as JavaScript Object Notation (JSON), base64, or the like), embedding the converted parameters into a QR code image (such as by using a suitable QR code generator), and physically printing or displaying the QR code image such that the computer vision system may capture an image of the QR code using the camera. Thereafter, an extraction module (such as the extraction module 230 of FIG. 2) may use one or more feature detection techniques to locate the QR code within the captured image, and extract the updated parameters embedded therein, such as by using pyzbar or another suitable programming library for reading QR codes.

QR codes are a desirable method for conveying information for a complex system-such as NN parameters-due to having high information density, i.e., large amounts of NN information can be stored in a small space. Furthermore, QR codes have a built-in error correction feature, allowing them to be read even if partially damaged or obscured. In addition, QR codes are flexible in that they can include portions of human-readable text, designs, or images. In some implementations, to increase security, a digital signature may also be included in a QR code to be verified by the computer vision system, such as prior to determining that the QR code includes an encoded message. In some other implementations, different visual techniques for encoding information may be used, such as barcodes, AprilTags, data matrix codes, patterns of geometric shapes, patterns of colors, or the like.

The encoded message 404 within input token 402 is embedded within an example QR code showing example (simplified) pixels that can be decoded as NN parameters. A known set of pixels 406 (representing a design of a letter “P” within a stylized bounding box) is shown in the center of the QR code. In some implementations, when the controller 210 identifies that a QR code is present within the input token 402, the controller 210 may determine whether a known set of pixels 406 is present within the input token 402. In such implementations, upon detecting the known set of pixels 406, the controller 210 may determine that the input token 402 includes an encoded message. In this manner, the controller 210 refrains from falsely determining that any randomly detected QR code includes an encoded message. It is to be understood that the design shown in input token 402 is a simplified example of a known set of pixels for purposes of illustration.

Upon determining that the input token 402 includes the encoded message 404, the computer vision system may pass the input token 402 to an extraction module (such as the extraction module 230 of FIG. 2) that extracts updated NN parameters from the encoded message 404.

In some implementations, a resolution or pixel density of the encoded message 404 increases with a quantity of the NN parameters to be updated. In some aspects, each pixel representing the encoded message 404 may indicate a new value for an existing parameter associated with the NN model. For example, a relatively high number of pixels in the encoded message 404 may be used when a relatively high number of NN parameters are to be updated, and vice versa.

It is to be understood that information other than NN parameters may be conveyed via the encoded message 404. In some implementations, the encoded message 404 includes credentials for a wireless network. By encoding wireless credentials into the encoded message 404, the process of entering wireless credentials (such as a Wi-Fi password) may be simplified, such as when the computer vision system is a small internet of things (IOT) device with limited input capabilities.

As described with reference to FIG. 2, an accuracy of the new parameters may be verified prior to using the new parameters to update the NN. For example, if noise is on the camera during capture of the input token 402 (e.g., a bird flies between the camera lens and the physical representation of the QR code), any parameters extracted from the captured image may be in-error and thus fail the parameter verification process. In such instances, the computer vision system may attempt to recapture the input token 402, or otherwise, pause or abort the parameter update process.

In some implementations, the input token 402 includes a coordinates pattern (not shown for simplicity) identifying an expected grid of pixels to which the computer vision system may align the input token 402. Specifically, upon identifying the coordinates pattern in the input token 402, the extraction module 230 may adjust at least one of a position, a rotation, or a scale of the input token 402 based on the coordinates pattern. Once the input token 402 is aligned with the expected grid of pixels, the extraction module 230 may decode the encoded message and extract the new NN parameters. In this manner, the computer vision system prevents incorrect values from being extracted from the encoded message 404 due to misalignment.

FIG. 4B shows another example input token 412 that can be captured by a computer vision system, according to some implementations. The input token 412 includes an encoded message 414 in which updated parameters for a neural network (NN) may be embedded. For the example input token 412, the updated parameters are encoded within a quick-response (QR) code showing example (simplified) pixels that can be decoded as the updated NN parameters.

In some instances, one or more colors may be used within the input token 412 to increase an amount of data that can be extracted from the encoded message 414. For example, if a camera of the computer vision system is configured to capture color images (e.g., of passing vehicles), one or more colors may be used in the input token 412 to convey additional data. In this manner, a number of parameters conveyed via the encoded message 414 can be increased without increasing a physical size of the input token 412 and/or a number of input tokens 412 needed to convey the updated parameters.

As shown using different shades of gray, a known color pattern 408 appears within the input token 412. In some implementations, when the QR code is identified as present within the input token 412, the computer vision system may determine whether the known color pattern 408 is present within the input token 412. In such implementations, upon detecting the known color pattern 408, the computer vision system may determine that the input token 412 includes an encoded message. It is to be understood that the different shades of gray shown in input token 412 is a simplified example of a known color pattern for purposes of illustration.

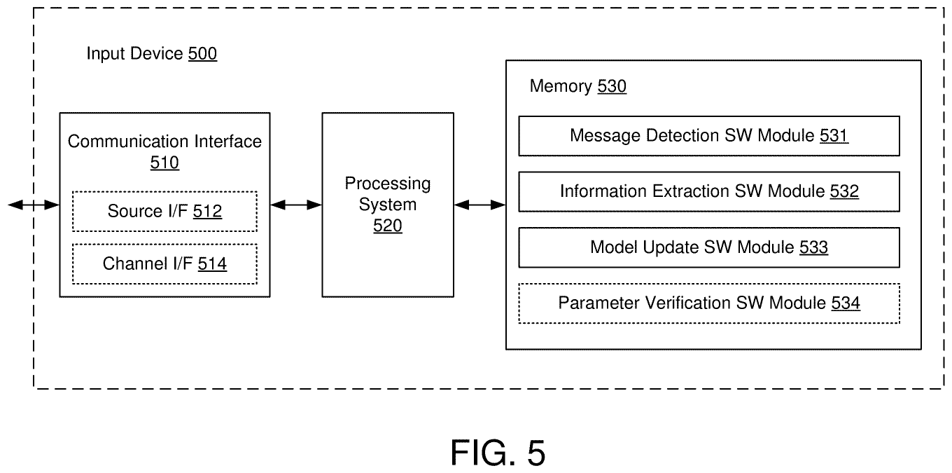

FIG. 5 shows a block diagram of an example input device 500, according to some implementations. In some implementations, the input device 500 may be one example of the input device 100 of FIG. 1. More specifically, the input device 500 may implement a neural network (NN) model trained to perform inferencing on input tokens received via one or more sensors of the input device.

The input device 500 includes a communication interface 510, a processing system 520, and a memory 530. The communication interface 510 is configured to receive a first input token via a source (such as the one or more sensors). In some aspects, the communication interface 510 may include a source interface (I/F) 512 for communicating with the source and a channel interface 514 for communicating over the communication channel. In some implementations, the first input token may be an image (such as when the one or more sensors include a camera). In some other implementations, the first input token may be an audio signal (such as when the one or more sensors include a microphone).

The memory 530 may include a non-transitory computer-readable medium (including one or more nonvolatile memory elements, such as EPROM, EEPROM, Flash memory, a hard drive, and the like) that may store at least the following software (SW) modules:
a message detection SW module 531 to determine that the first input token includes an encoded message;
an information extraction SW module 532 to extract NN information from the encoded message; and
a model update SW module 533 to update one or more parameters of the NN model based on the extracted NN information.
   In some implementations, the non-transitory computer-readable medium may also store at least the following SW module:
a parameter verification SW module 534 to verify an accuracy of the extracted NN information prior to the updating of the NN model.
   Each software module includes instructions that, when executed by the processing system 520, cause the input device 500 to perform the corresponding functions.

The processing system 520 may include any suitable one or more processors capable of executing scripts or instructions of one or more software programs stored in the input device 500 (such as in the memory 530). For example, the processing system 520 may execute the message detection SW module 531 to determine that the first input token includes an encoded message. The processing system 520 may execute the information extraction SW module 532 to extract NN information from the encoded message. The processing system 520 may execute the model update SW module 533 to update one or more parameters of the NN model based on the extracted NN information. In some implementations, the processing system 520 may further execute the parameter verification SW module 534 to verify the accuracy of the extracted NN information prior to the updating of the NN model.

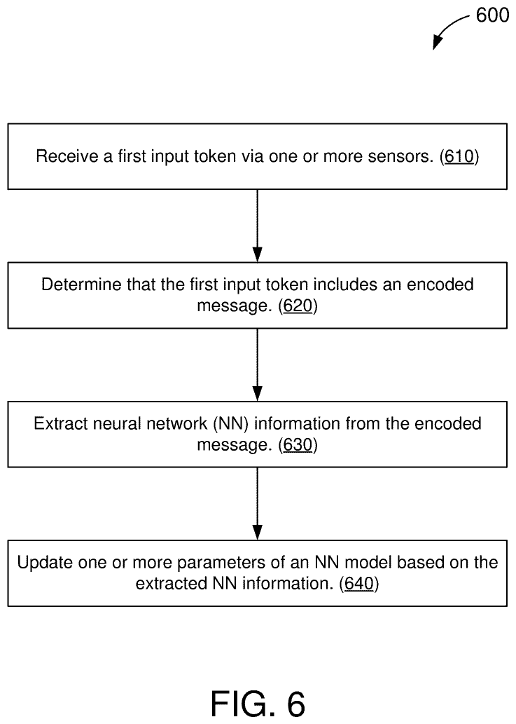

FIG. 6 shows an illustrative flowchart depicting an example operation 600 for updating neural network (NN) parameters, according to some implementations. In some implementations, the example operation 600 may be performed by an input device such as the data analysis system 200 of FIG. 2 or the input device 500 of FIG. 5. The input device may implement a NN model trained to perform inferencing on input tokens received via one or more sensors of the input device.

The input device receives a first input token via the one or more sensors (610). The input device determines that the first input token includes an encoded message (620). The input device extracts NN information from the encoded message (630). The input device updates one or more parameters of the NN model based on the extracted NN information (640).

In some implementations, the one or more sensors include a camera and the first input token includes an image captured via the camera. In some aspects, the determining that the first input token includes an encoded message includes detecting a known pixel pattern in the received image. In some other aspects, the image includes a plurality of pixels each representing a new value for a current parameter of the NN model, and a resolution of the image increases with a quantity of the current parameters to be updated. In yet other aspects, the extracting the NN information includes identifying a coordinates pattern in the received image, adjusting at least one of a position, a rotation, or a scale of the first input token based on the coordinates pattern, and decoding the encoded message based on the adjusted first input token.

In some other implementations, the one or more sensors include a microphone and the first input token includes an audio signal captured via the microphone. In some aspects, the determining that the first input token includes an encoded message includes detecting a known audio pattern in the received audio signal.

In some aspects, the input device receives a second input token via the one or more sensors, determines that the second input token does not include an encoded message, and performs an inferencing operation on the second input token based on the updated NN model.

In some implementations, the extracted NN information includes at least one of an updated weight value or an updated bias value for the NN model. In some aspects, the input device verifies an accuracy of the updated weight value or the updated bias value prior to updating the NN model.

In some implementations, the NN model is a hardware-based NN model implemented in a silicon chip, and the one or more parameters of the NN model are programmed in the silicon chip during manufacturing.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method performed by an input device implementing a neural network (NN) model trained to perform inferencing on input tokens received via one or more sensors of the input device, comprising:
receiving a first input token via the one or more sensors;
determining that the first input token includes an encoded message;
extracting NN information from the encoded message; and
updating one or more parameters of the NN model based on the extracted NN information.

2. The method of claim 1, wherein the one or more sensors include a camera and the first input token comprises an image captured via the camera.

3. The method of claim 2, wherein the determining that the first input token includes an encoded message comprises detecting a known pixel pattern in the received image.

4. The method of claim 2, wherein the image includes a plurality of pixels each representing a new value for a current parameter of the NN model, and wherein a resolution of the image increases with a quantity of the current parameters to be updated.

5. The method of claim 2, wherein the extracting the NN information includes:
identifying a coordinates pattern in the received image;
adjusting at least one of a position, a rotation, or a scale of the first input token based on the coordinates pattern; and
decoding the encoded message based on the adjusted first input token.

6. The method of claim 1, wherein the one or more sensors include a microphone and the first input token comprises an audio signal captured via the microphone.

7. The method of claim 6, wherein the determining that the first input token includes an encoded message comprises detecting a known audio pattern in the received audio signal.

8. The method of claim 1, further comprising:
receiving a second input token via the one or more sensors;
determining that the second input token does not include an encoded message; and
performing an inferencing operation on the second input token based on the updated NN model.

9. The method of claim 1, wherein the extracted NN information includes at least one of an updated weight value or an updated bias value for the NN model.

10. The method of claim 9, further comprising:
verifying an accuracy of the updated weight value or the updated bias value prior to updating the NN model.

11. The method of claim 1, wherein the NN model is a hardware-based NN model implemented in a silicon chip, and wherein the one or more parameters of the NN model are programmed in the silicon chip during manufacturing.

12. An input device, comprising:
one or more sensors;
a neural network (NN) model trained to perform inferencing on input tokens received via the one or more sensors;
a processing system; and
a memory storing instructions that, when executed by the processing system, causes the input device to perform operations including:
receiving a first input token via the one or more sensors;
determining that the first input token includes an encoded message;
extracting NN information from the encoded message; and
updating one or more parameters of the NN model based on the extracted NN information.

13. The input device of claim 12, wherein the one or more sensors include a camera and the first input token comprises an image captured via the camera.

14. The input device of claim 13, wherein the determining that the first input token includes an encoded message comprises detecting a known pixel pattern in the received image.

15. The input device of claim 13, wherein the image includes a plurality of pixels each representing a new value for a current parameter of the NN model, and wherein a resolution of the image increases with a quantity of the current parameters to be updated.

16. The input device of claim 13, wherein the extracting the NN information includes:
identifying a coordinates pattern in the received image;
adjusting at least one of a position, a rotation, or a scale of the first input token based on the coordinates pattern; and
decoding the encoded message based on the adjusted first input token.

17. The input device of claim 12, wherein the one or more sensors include a microphone and the first input token comprises an audio signal captured via the microphone.

18. The input device of claim 17, wherein the determining that the first input token includes an encoded message comprises detecting a known audio pattern in the received audio signal.

19. The input device of claim 12, wherein execution of the instructions causes the input device to perform operations further including:
receiving a second input token via the one or more sensors;
determining that the second input token does not include an encoded message; and
performing an inferencing operation on the second input token based on the updated NN model.

20. The input device of claim 13, wherein the extracted NN information includes at least one of an updated weight value or an updated bias value for the NN model, and wherein execution of the instructions causes the input device to perform operations further including:
verifying an accuracy of the updated weight value or the updated bias value prior to updating the NN model.
